(19) United States
(12) Patent Application Publication
(10) Pub. No.: US 2007/0283170 A1
(43) Pub. Date: Dec. 6, 2007

(54) System and method for secure inter-process data communication

(75) Inventors: Sameer Yami, Irvine, CA (US); Amir Shahindoust, Laguna Niguel, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/446,874

(22) Filed: Jun. 5, 2006

(51) Int. Cl. G06F 12/14

(52) U.S. Cl. 713/193

(57) ABSTRACT

A system and method for secure inter-process data communication is provided. Identification data corresponding to a user is received and used to generate a symmetric encryption key. The symmetric encryption key is then used to encrypt job data. A token associated with the encrypted job data is then generated. Expiration data corresponding to the validity period of the token is then associated with the token, whereupon the token is stored. The generated symmetric key is then encrypted using a static symmetric encryption key, whereupon the encrypted symmetric key is also stored in association with the token. When a process receives the encrypted job data, the process retrieves the token and determines, based on the expiration data whether the token is still valid. When the token is valid, the static key is retrieved and used to decrypt the encrypted encryption key. The decrypted encryption key is then used to decrypt the job data, whereupon the process performs the function associated therewith upon the decrypted job data.

### BACKGROUND OF THE INVENTION

The subject application is directed to a system and process for secure inter-process data communication. In particular, the subject application is directed to a system and method for transmitting authentication information between processes without user intervention so as to allow for monitoring of state transitions to verify secure operation.

Digital computers typically function with software that runs one or more processes or threads, each of which results in a state transition. A state of a machine reflects its status at a given time, including a state of memory, input/output, functionality and the like. Many devices rely on digital computers for control or monitoring of all or some of their functionality. The controller architecture of a device, such as multifunction peripheral device typically consists of multiple processes, each performing a specific function in a document processing job. Many systems have been developed to provide security for data that is input or output from a device. However, there is vulnerability when data is received into a system, and decrypted, when such decrypted data is passed among or between various processes. Systems, and particularly networked or shared systems, are vulnerable to hacking or intrusion. Unauthorized users may be able to compromise a system and intercept data that is passed between processes.

If a user has requested a secure document processing job, such as a private print job, the data pertaining to such job must be encrypted any time such data is stored in persistent memory. Therefore, each process in the performance of the job must have access to the user authentication or key information in order to decrypt the job data for processing and then encrypt the job data when it is again stored in memory. The transmission of the user authentication and key information between processes should proceed transparently and automatically without the need for the user to supply the required information to each process. In addition, the job data needs to be protected against a third party being able to intercept the information during transmission between processes. Also, a system should be able to detect when an intrusive or errant process has interrupted a normal flow of processing or information which is indicative of a vulnerability for sensitive or confidential information.

The subject application overcomes the above noted problems and provides a system and method for secure inter-process communications.

### SUMMARY OF THE INVENTION

In accordance with the subject application, there is provided a system and method for secure inter-process communications.

Further, in accordance with the subject application, there is provided a system and method for transmitting authentication information between processes without user intervention so as to allow for monitoring of state transitions to verify secure operation.

Still further, in accordance with the subject application, there is provided a system for secure inter-process communication. The system includes means adapted for receiving job data and means adapted for receiving symmetric key data. The system also includes encryption means adapted for encrypting the job data in accordance with the key data and token generator means adapted for generating token data uniquely associated with encrypted job data. The system further includes key data encryption means adapted for encrypting the key data to generate an encrypted key, storage means adapted for storing the token data and encrypted key data, and means adapted for receiving encrypted data into each of a plurality of processes. The system also comprises means adapted for retrieving token data and encrypted key data in accordance with each of the plurality of processes and decrypting means adapted for decrypting encrypted data in each of the plurality of processes in accordance with retrieved token data and retrieved encrypted key data.

Still further, in accordance with the subject application, there is provided a method for secure inter-process communications. The method includes receiving job data and symmetric key data and encrypting the job data in accordance with the key data. Token data uniquely associated with encrypted job data is generated and the key data is encrypted to generate an encrypted key. The token data and the key data are stored in an associated storage. Encrypted data is received into each of a plurality of processes. Token data and encrypted key data are retrieved in accordance with each of the plurality of processes and the encrypted data in each of the plurality of processes is decrypted in accordance with retrieved token data and retrieved encrypted key data.

In one embodiment, the system and method further include the ability to receive temporal data into the associated storage. The temporal data is tested in accordance with each of the plurality of processes and a decryption operation is selectively prevented in accordance with an output of the testing. Preferably, the temporal data includes data representative of an expiration time associated with the token data.

In another embodiment, the system and method also include the ability to receive user data representative of an associated user and generate the symmetric key data in accordance with received user data.

In still another embodiment, the token data is generated in accordance with current time.

In yet another embodiment, the key data is encrypted in accordance with the symmetric key data.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall system diagram of the system for secure inter-process communications according to the subject application;

FIG. 2 is a block diagram illustrating controller hardware for use in the system for secure inter-process communications according to the subject application;

FIG. 3 is a functional block diagram illustrating the controller for use in the system for secure inter-process communications according to the subject application;

FIG. 4 is a flowchart illustrating the method for generating a token in accordance with the method for secure inter-process communications according to the subject application; and

FIG. 5 is a flowchart illustrating the method for using a token in accordance with the method for secure inter-process communications according to the subject application.

### DETAILED DESCRIPTION OF THE PREFERRED EMBODIMENT

The subject application is directed a system and method for secure inter-process communications. In particular, the subject application is directed to a system and method for transmitting authentication information between processes without user intervention so as to allow for monitoring of state transitions to verify secure operation.

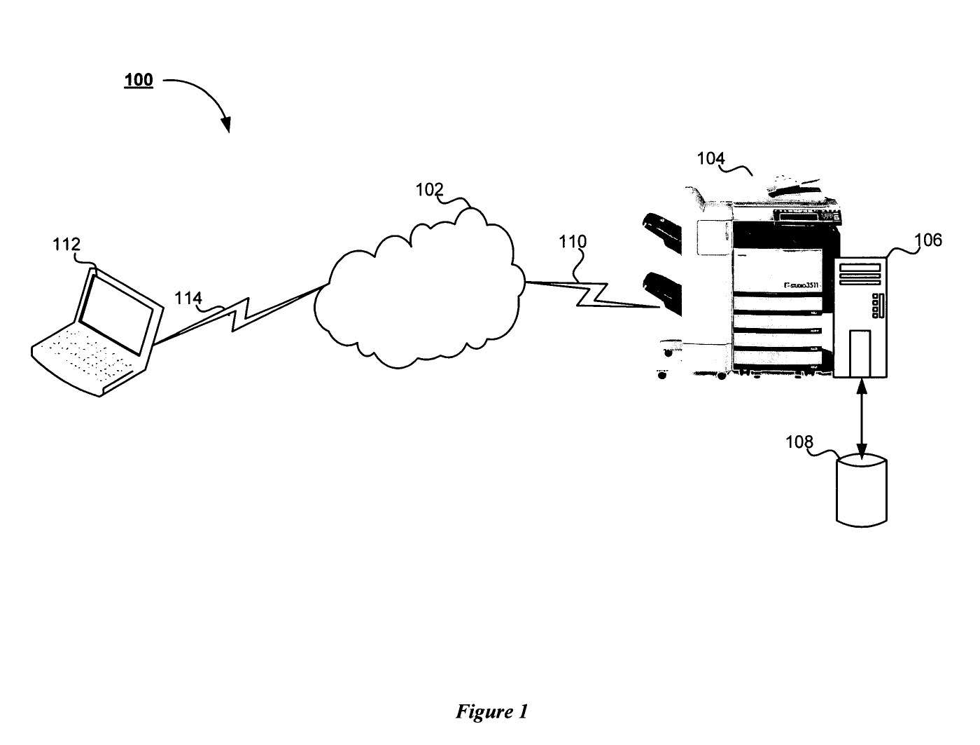

Turning now to FIG. 1, there is depicted a diagram illustrating an overall system 100 for secure inter-process communications in accordance with the subject application. As shown in FIG. 1, the system 100 includes a distributed computing environment, represented as a computer network 102. It will be understood by those skilled in the art that the computer network 102 is any distributed communications environment known in the art capable of enabling the exchange of data between two or more electronic devices. The skilled artisan will further understand that the computer network 102 is any computer network, known in the art, including for example, and without limitation, a local area network, a wide area network, a personal area network, a virtual network, an intranet, the Internet, or any combination thereof. In the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wire-based or wireless data communication mechanisms.

The system 100 also includes a document processing device 104, represented as a multifunction peripheral device. It will be understood by those skilled in the art the document processing device 104 is suitably adapted to provide a variety of document processing services, such as, for example and without limitation, electronic mail, scanning, copying, facsimile, document management, printing, and the like. Suitable commercially available document rendering devices include, but are not limited to, the Toshiba e-Studio Series Controller. In one embodiment, the document processing device 104 is suitably equipped to receive a plurality of portable storage media, including without limitation, Firewire drive, USB drive, SD, MMC, XD, Compact Flash, Memory Stick, and the like. In the preferred embodiment of the subject application, the document processing device 104 further includes an associated user-interface, such as a touch-screen interface, LCD display, or the like, via which an associated user is able to interact directly with the document processing device 104.

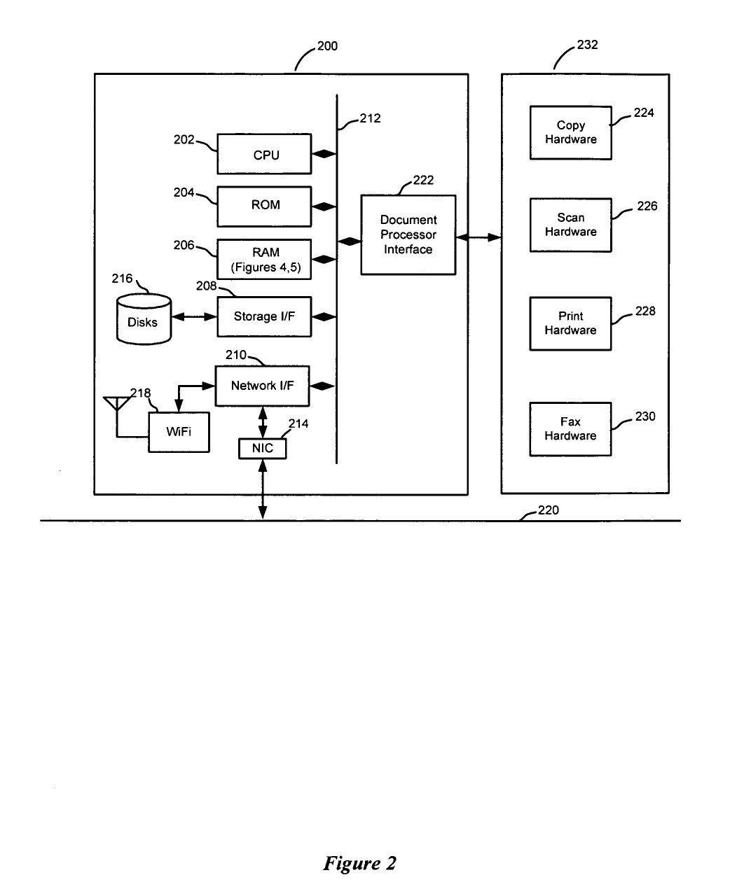

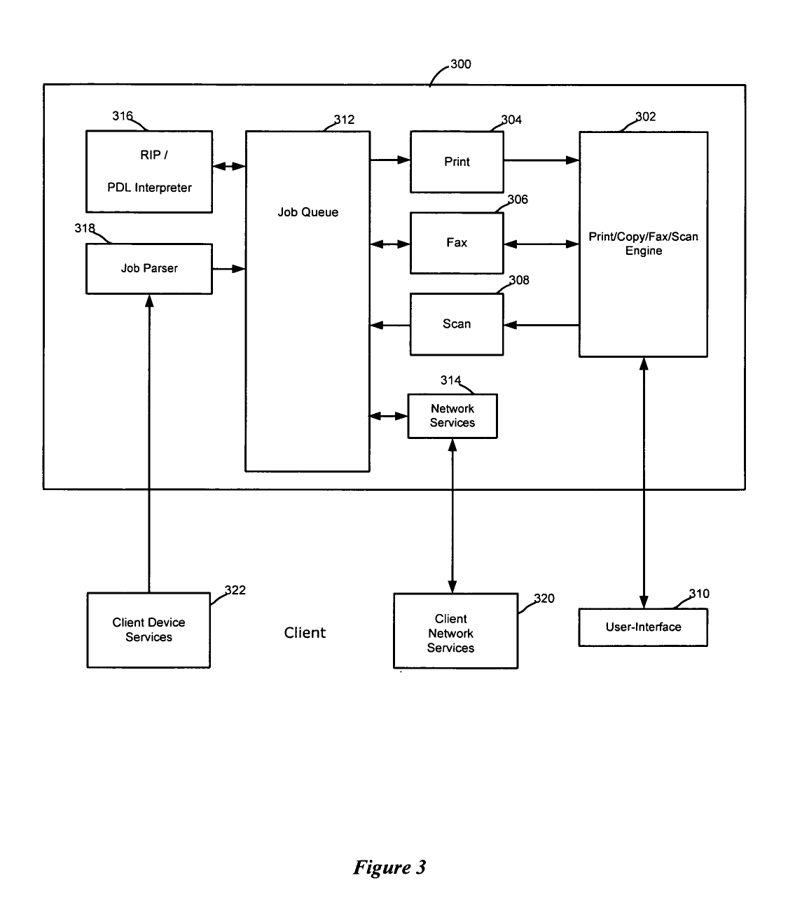

Operatively coupled to the document processing device 104 is a controller 106, as illustrated in FIG. 1. As will be appreciated by those skilled in the art, the controller 106 is any software, hardware, or combination thereof, suitably adapted to provide control functionality to the document processing device 104. In accordance with the preferred embodiment of the subject application, the controller 106 further includes architecture comprising a plurality of processes, wherein each process performs a particular function on a document processing operation. Further in accordance with the preferred embodiment of the subject application, the controller 106 also includes secure document processing capabilities, as will be apparent to one of ordinary skill in the art. In addition to the foregoing, the controller 106 further incorporates a security library, suitably adapted to generate encryption keys and manage access thereto. The skilled artisan will appreciate that while a controller 106 is shown in FIG. 1, the subject application is capable of being employed on any computing device, known in the art, capable of running multiple processes. The functionality of the controller 106 will be explained in greater detail below, with respect to FIGS. 2 and 3.

Preferably, a persistent data storage, such as data storage device 108, is communicatively coupled to the controller 106, suitably adapted to provide storage services to the processes running on the document processing device 104, user authentication information, and the like. As will be understood by those skilled in the art, the data storage device 108 is any mass storage device known in the art including, for example and without limitation, a hard disk drive, other magnetic storage devices, optical storage devices, flash memory devices, or any combination thereof. In accordance with one embodiment of the subject application, the document processing device 104 is in data communication with the computer network 102 via a suitable communications link 110. As will be appreciated by the skilled artisan, a suitable communications links 110 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art.

The system 100 illustrated in FIG. 1 further includes at least one client device 112. Preferably, the client device 112 is communicatively coupled to the computer network 102 via a suitable communications link 114. It will be appreciated by those skilled in the art that the client device 112 is depicted in FIG. 1 as a laptop computer for illustration purposes only. As the skilled artisan will understand, the client device 112 shown in FIG. 1 is representative of any personal computing device known in the art, including, for example and without limitation, a computer workstation, a personal computer, a personal data assistant, a web-enabled cellular telephone, a smart phone, or other web-enabled electronic device suitably capable of generating and/or transmitting electronic document data to a multifunctional peripheral device. The communications link 114 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. In the preferred embodiment, the client device 112 is suitably adapted generate a document processing request, or job request.

Turning now to FIG. 2, illustrated is a representative architecture of a suitable controller 200, shown in FIG. 1 as the controller 106, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device that includes the controller 200 of FIG. 2 as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

In operation, the document processing device 104 receives job data from the client device 112 representative of a requested document processing operation. Preferably, the job data includes data representing a selected document processing operation, such as, for example and without limitation, print, copy, facsimile, scan, scan-to-electronic mail, scan-to-storage, document management, or the like. More preferably, the job data is representative of a secure document processing request, thereby requiring the document processing device 104 to maintain the privacy of the job data and prevent unauthorized users from viewing such data. The skilled artisan will appreciate that when the job data received by the document processing device 104 corresponds to a secure document processing operation, the data associated therewith is required to be encrypted whenever it is stored in a persistent memory, for example, in the data storage device 108 between processes. In addition to receiving the job data, the document processing device 104 receives user identification data associated with the user submitting the received document processing request. In accordance with one embodiment of the subject application, the identification data includes, for example and without limitation, a user ID/password combination, password, or other suitable user identifying data known in the art.

The controller 106, via a security library component resident thereon, uses the received user identification data to generate a unique symmetric encryption key. The controller 106, via any suitable means, then receives expiration data representative of a time period during which a token, as will be discussed below, will remain active. The skilled artisan will appreciate the expiration data is capable of being predetermined by a network administrator, a preset time period, the type of operation with which the token is associated, and the like. The job data is then encrypted by the controller 106 using the symmetric encryption key, and a token associated with the encrypted job data and expiration data is then generated. In one embodiment of the subject application, the token is generated in accordance with the current time. A static random symmetric encryption key is then retrieved by the controller 106 and used to encrypt the symmetric key generated from the user identification data. Preferably, the static symmetric key is generated by the controller 106 during start-up of the document processing device 104. In the preferred embodiment of the subject application, the static symmetric key is used to encrypt all other encryption keys generated for various documents during the period the document processing device 104 is operational. Upon shutdown and restart, a new static key is generated by the controller 106 for use during document processing operations. In such an embodiment, the static symmetric key is advantageously stored in the data storage device 108, thereby available for subsequent operations. The token and encrypted key data is then stored in the associated storage 108 for later use by subsequent processes.

When a process receives encrypted job data, the token associated therewith, along with the encrypted key data, is retrieved from the associated storage 108. The process that has received the encrypted data on the controller 106 then retrieves the expiration data associated with the token and a determination is made whether the token has expired. When the period of time allotted by the expiration data has run, i.e., expired, the process is denied the ability to decrypt the encrypted job data and the document processing operation terminates. When the controller 106, via the current process, determines that the token has not expired, the static symmetric key is used to decrypt the encrypted symmetric key, which was generated from the user identification data. Once the generated unique symmetric key has been decrypted, the job data is decrypted using the key. The function associated with the current process is then performed on the job data. A determination is then made whether additional processes remain to access the job data. When no additional processes remain, the document processing operation is complete. When subsequent processes remain to be processed, the job data output by the recently completed process is then encrypted using the unique symmetric encryption key, whereupon the next process receives the encrypted data. The next process thereafter retrieves the token data and encrypted data and proceeds thereon as set forth above. It will be appreciated by those skilled in the art that in accordance with one embodiment of the subject application, that the first process, upon successful completion of its associated function, transmits token data, encrypted key data, and job data to the next process.

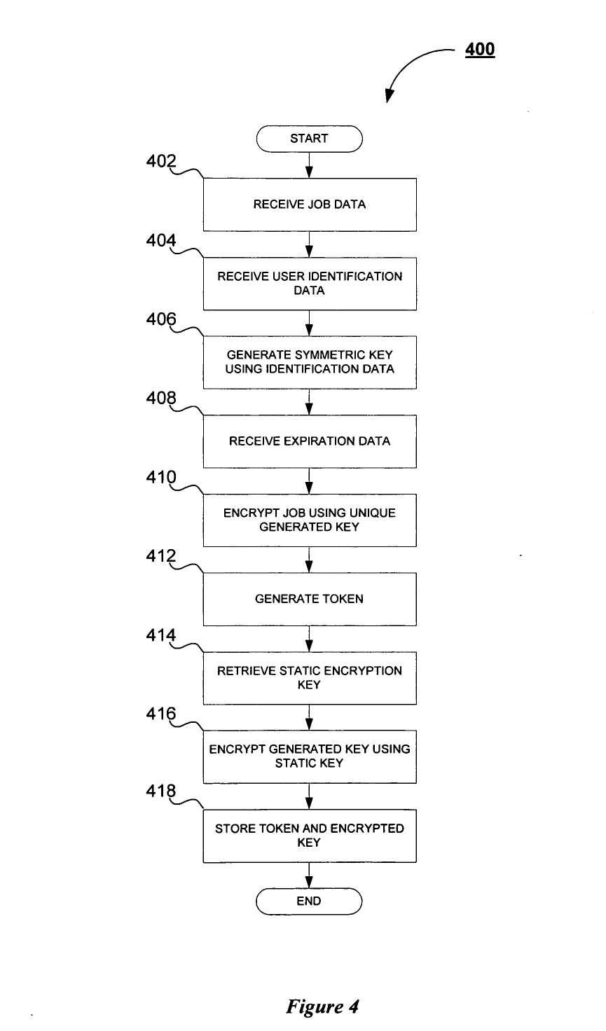

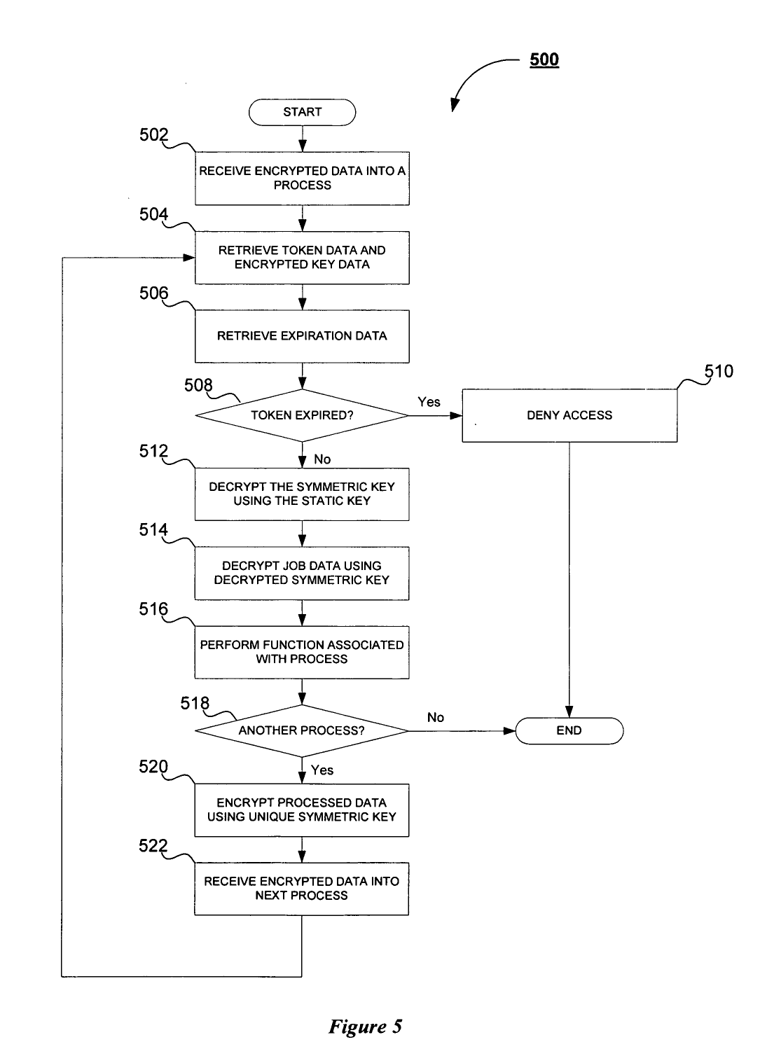

The foregoing system 100 and components shown in FIGS. 1, 2, and 3 will better be understood when viewed in conjunction with the methodologies illustrated in FIG. 4 and FIG. 5. Referring now to FIG. 4, there is shown a flowchart 400 illustrating a method for generating a token in accordance with the method for secure inter-process communications according to the subject application. Beginning at step 402, the controller 106, via the document processing device 104, receives job data from an associated user. Preferably, the job data is received from the client device 112 over the computer network 102, however the skilled artisan will appreciate that the user is also capable of submitting job data via the associated user-interface proximate to the document processing device 104. In accordance with the preferred embodiment of the subject application, the job data includes data representative of a selected document processing operation, electronic document data, document processing data, or the like. The controller 106 then receives, from the associated user, user identification data at step 404. As will be understood by those skilled in the art, user identification includes, for example and without limitation, a user ID/password combination, biometric identification, and other user identifying indicia as are known in the art.

A security library, a component resident on the controller 106, then generates symmetric encryption key using the user identification data received from the associated use at step 406. The generation of the encryption key is suitable accomplished via any means known in the art capable of generating encryption keys. At step 408, expiration data representative of the validity time period of a generated token is received by the controller 106. It will be appreciated by those skilled in the art the expiration data is capable of being pre-established by a network administrator, preset during setup of the document processing device, and the like. The job data is then encrypted using the generated encryption key at step 410, resulting in encrypted job data. A token associated with the encrypted job data and the expiration data is then generated at step 412. In one embodiment, the token is generated using the current time. A random static encryption key is then retrieved at step 414. The encryption key generated from the user identification data is then encrypted using the retrieved static encryption key at step 416. The encrypted encryption key and token are then stored in the associated data storage 108 at step 418.

The skilled artisan will appreciate that the subject application enables the generation of a token for each document processing request from an associated user. Stated another way, according to the subject application, first the user identification data in the form of a user ID/password combination, a period of validity associated with the token, and job data are received. Then both encrypted job data and the encrypted token, which is then capable of use by subsequent processes are output. As stated above, the security library resident on the controller 106 uses the user ID/password combination to generate a unique symmetric key used to encrypt the job data. The unique encryption key, in addition to other user information and expiration data, is then encrypted using a static random symmetric key and stored in associated memory 108 as an encrypted blob. The blob is then mapped to a string, based upon a hash of the encrypted data. The skilled artisan will appreciate that he term blob, as used herein, references a structure comprising different encryption entities, e.g., keys, encrypted data, and the like, grouped together. The skilled artisan will appreciate that the hash of the internal data functions as a unique token. Thus, when a process provides a user ID/password, it receives the encrypted data and the unique token string. The skilled artisan will further appreciate that the process is then able to pass the string to subsequent processes, while requiring those subsequent processes desiring access to secure data to pass the encrypted data and the unique token string. The next process, after checking for expiration of the token, creates a hash of the encrypted data to re-create the token and compares the re-created token against the provided token. Upon successful verification, the encrypted blob is located on the memory map and decrypted by the static key to the recover the actual data encryption key. Thereafter, the encryption key is used to decrypt the data.

The preceding explanation will better be understood when viewed in conjunction with the method for using the tokens, as set forth in FIG. 5. Referring now to FIG. 5, there is shown a flowchart 500 illustrating the method for using a token in accordance with the method for secure inter-process communications according to the subject application. Beginning at step 502, encrypted data is received into a process via any suitable means known in the art. The token data and encrypted key data associated with the received encrypted data is then retrieved via any suitable means at step 504. The expiration data associated with the token is then retrieved at step 506 and flow proceeds to step 508 for a determination whether the token has expired. When the controller 106 determines at step 508 that the token is no longer valid, i.e., that the token has expired, flow proceeds to step 510, whereupon the process is denied access to the static key for decrypting the encrypted key data.

When it is determined at step 508 that the token remains valid, i.e., the token has not expired, flow proceeds to step 512, whereupon the encrypted unique symmetric key is decrypted using the static encryption key by the security library component of the controller 106. After decryption of the unique symmetric key, flow proceeds to step 514, whereupon the job data is decrypted using the unique symmetric key. Once the job data has been decrypted, the process on the document processing device 104 then performs the function associated therewith on the decrypted job data at step 516. A determination is then made at step 518 whether any additional processes remain in the document processing operation. When no further processes remain, the operation terminates. When one or more processes remain, flow proceeds to step 520, whereupon the data resulting from the previously completed process is encrypted using the unique symmetric key. The encrypted data is then received by the next process at step 522 and the next process retrieves the token data and encrypted key data at step 504. Operations then continue thereon after in accordance with the methodologies described above.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for secure inter-process data communication comprising:
means adapted for receiving job data;
means adapted for receiving symmetric key data;
encryption means adapted for encrypting the job data in accordance with the key data;
token generator means adapted for generating token data uniquely associated with encrypted job data;
key data encryption means adapted for encrypting the key data to generate an encrypted key;
storage means adapted for storing the token data and encrypted key data;
means adapted for receiving encrypted data into each of a plurality of processes;
means adapted for retrieving token data and encrypted key data in accordance with each of the plurality of processes; and
decrypting means adapted for decrypting encrypted data in each of the plurality of processes in accordance with retrieved token data and retrieved encrypted key data.

2. The system for secure inter-process data communication of claim 1 further comprising:
means adapted for receiving temporal data into the storage means;
testing means adapted for testing the temporal data in accordance with each of the plurality of processes; and
prevention means adapted for selectively preventing a decryption operation by the decrypting means in accordance with an output of the testing means.

3. The system for secure inter-process data communication of claim 2 wherein the temporal data includes data representative of an expiration time associated with the token data.

4. The system for secure inter-process data communication of claim 3 further comprising:
means adapted for receiving user data representative of an associated user; and
means adapted for generating the symmetric key data in accordance with received user data.

5. The system for secure inter-process data communication of claim 4 wherein the token generator means includes means adapted for generating the token data in accordance with current time.

6. The system for secure inter-process data communication of claim 5 wherein the key data encryption means includes means adapted for encrypting the key data in accordance with the symmetric key data.

7. A method for secure inter-process data communication comprising the steps of:
receiving job data;
receiving symmetric key data;
encrypting the job data in accordance with the key data;
generating token data uniquely associated with encrypted job data;
encrypting the key data to generate an encrypted key;
storing the token data and encrypted key data in an associated storage;
receiving encrypted data into each of a plurality of processes;
retrieving token data and encrypted key data in accordance with each of the plurality of processes; and
decrypting encrypted data in each of the plurality of processes in accordance with retrieved token data and retrieved encrypted key data.

8. The method for secure inter-process data communication of claim 7 further comprising the steps of:
receiving temporal data into the associated storage;
testing the temporal data in accordance with each of the plurality of processes; and
selectively preventing a decryption operation in accordance with an output of the testing.

9. The method for secure inter-process data communication of claim 8 wherein the temporal data includes data representative of an expiration time associated with the token data.

10. The method for secure inter-process data communication of claim 9 further comprising the steps of:
receiving user data representative of an associated user; and
generating the symmetric key data in accordance with received user data.

11. The method for secure inter-process data communication of claim 10 wherein the token data is generated in accordance with current time.

12. The method for secure inter-process data communication of claim 11 wherein the key data is encrypted in accordance with the symmetric key data.

13. A computer-implemented method for secure inter-process data communication comprising the steps of:
receiving job data;
receiving symmetric key data;
encrypting the job data in accordance with the key data;
generating token data uniquely associated with encrypted job data;
encrypting the key data to generate an encrypted key;
storing the token data and encrypted key data in an associated storage;
receiving encrypted data into each of a plurality of processes;
retrieving token data and encrypted key data in accordance with each of the plurality of processes; and
decrypting encrypted data in each of the plurality of processes, in accordance with retrieved token data and retrieved encrypted key data.

14. The computer-implemented method for secure inter-process data communication of claim 13 further comprising the steps of:
receiving temporal data into the associated storage;
testing the temporal data in accordance with each of the plurality of processes; and
selectively preventing a decryption operation in accordance with an output of the testing.

15. The computer-implemented method for secure inter-process data communication of claim 14 wherein the temporal data includes data representative of an expiration time associated with the token data.

16. The computer-implemented method for secure inter-process data communication of claim 15 further comprising the steps of:
receiving user data representative of an associated user; and
generating the symmetric key data in accordance with received user data.

17. The computer-implemented method for secure inter-process data communication of claim 16 wherein the token data is generated in accordance with current time.

18. The computer-implemented method for secure inter-process data communication of claim 17 wherein the key data is encrypted in accordance with the symmetric key data.
